(19) United States
(12) Patent Application Publication
(10) Pub. No.: US 2011/0000093 A1
(43) Pub. Date: Jan. 6, 2011

(54) Kitchen tool construction

(75) Inventor: Franco Coppo, Milano (IT)

Correspondence Address: HEDMAN & COSTIGAN, P.C., 1230 AVENUE OF THE AMERICAS, 7th floor, NEW YORK, NY, 10020, US

(73) Assignee: SAMBONET PADERNO INDUSTRIE S.p.A., Milano (IT)

(21) Appl. No.: 12/800,893

(22) Filed: May 25, 2010

(30) Foreign Application Priority Data
Jul. 6, 2009 (IT) MI2009U 000227

(51) Int. Cl. B25G 3/00

(52) U.S. Cl. 30/345

(57) ABSTRACT

A kitchen tool or implement construction comprises a composite glass fiber reinforced polyamide material, preferably “Nylon 6.6”, and may be used for making kitchen implements such as flour sieving implements, ladles, large spoons, mixing spatulas, whisks, smooth and perforated vanes, skimmers, bread, salad, spaghetti, sweet, sugar springs and grippers.

### BACKGROUND OF THE INVENTION

The present invention relates to a kitchen tool or implement construction.

As is known, kitchen tools such as flour sieving implements, ladles, large spoons, mixing spatulas, whisks, smooth and perforated vanes, skimmers, bread, salad, spaghetti, sweet, sugar springs and grippers, are conventionally made of a stainless steel material.

Prior stainless steel kitchen tools or implements, however, have the drawback that they may scratch the surfaces of kitchen vessels coated and lined by an anti-adhering material, such as Teflon.

For the above reason, wood kitchen tools are preferably used.

On the other hand, wood may only be used for making a comparatively narrow range of kitchen tools, but not for making professional use kitchen tools or implements.

Actually, even in a home environment, wood is only used in few kitchen tools, i.e. tools provided for special functions.

Synthetic or plastics material kitchen tools or implements have also been designed.

All the above kitchen tools, however, do not have the required mechanical strength and high temperature resistance as required both in professional and conventional kitchen implements.

### SUMMARY OF THE INVENTION

Accordingly, the aim of the present invention is to provide such a kitchen tool or implement construction which overcomes all the above mentioned drawbacks of prior kitchen tools and implements.

Within the scope of the above mentioned aim, a main object of the invention is to provide such a kitchen tool construction which has a very high mechanical strength without damaging anti-adhering material coated and lined surfaces of kitchen vessels.

Another object of the present invention is to provide such a kitchen tool or implement construction having a very high resistance to high temperatures and which, moreover, may also be washed in dishwashers and safely and easily sterilized.

Yet another object of the present invention is to provide such a kitchen tool or implement which, owing to its specifically designed structural features, is very reliable and safe in operation.

According to one aspect of the present invention, the above mentioned aim and objects, as well as yet other objects, which will become more apparent hereinafter, are achieved by a kitchen tool construction, characterized in that said kitchen tool construction comprises a glass fiber reinforced polyamide composite material.

Said polyamide composite material comprises preferably “Nylon 6.6”.

The kitchen tool construction according to the present invention may be used for making a very high number of kitchen implements such as flour sieving implements, ladles, large spoons, mixing spatulas, whisks, smooth and perforated vanes, skimmers, bread, salad, spaghetti, sweet, sugar springs and grippers.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative, example in the accompanying drawings, where:

FIG. 1 is a perspective view of a ladle construction according to the present invention;

FIG. 2 is a perspective view of a mixing spatula construction according to the invention;

and

FIG. 3 is a further perspective view of a skimmer construction according to the present invention.

### DESCRIPTION OF THE PREFERRED EMBODIMENTS

With reference to the number references of the above mentioned figures, the present invention provides to make several types of kitchen tools or implements, such as flour sieving implements, ladles, large spoons, mixing spatulas, whisks, smooth and perforated vanes, skimmers, bread, salad, spaghetti, sweet, sugar springs and grippers.

According to the present invention, the kitchen tool or implement construction comprises a glass fiber reinforced polyamide composite material.

Preferably, said polyamide composite material comprises “Nylon 6.6”.

The thus made kitchen construction is adapted to resist against heating up to a temperature of 220° C. and, accordingly, it can be washed in dishwashers and may also be sterilized, as desired.

Thus, the composite construction kitchen tools or implements according to the present invention may be used with anti-adhering material coated or lined kitchen vessels, since said tools would not scratch the vessel surfaces.

As stated, the composite kitchen tool construction according to the present invention mat be used for making a very broad range of kitchen tools or implements comprising flour sieving implements, ladles, large spoons, mixing spatulas, whisks, smooth and perforated vanes, skimmers, bread, salad, spaghetti, sweet, sugar springs and grippers.

In this connection it should be pointed out that the above list is not an exhaustive one, the embodiments shown in the accompanying drawings illustrating only few of possible embodiments of the invention, the accompanying figures showing only some examples of kitchen tool constructions according to the present invention.

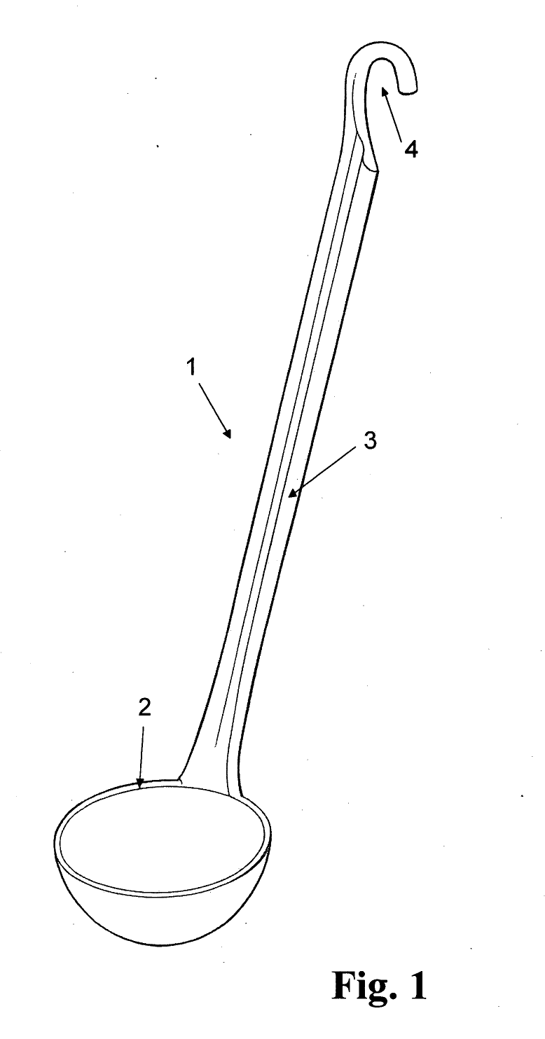

In particular, FIG. 1 shows a ladle, generally indicated by the reference number 1, comprising an operating portion 2 which is made in a single piece with the ladle handle 3, said ladle handle ending with a side hook element 4.

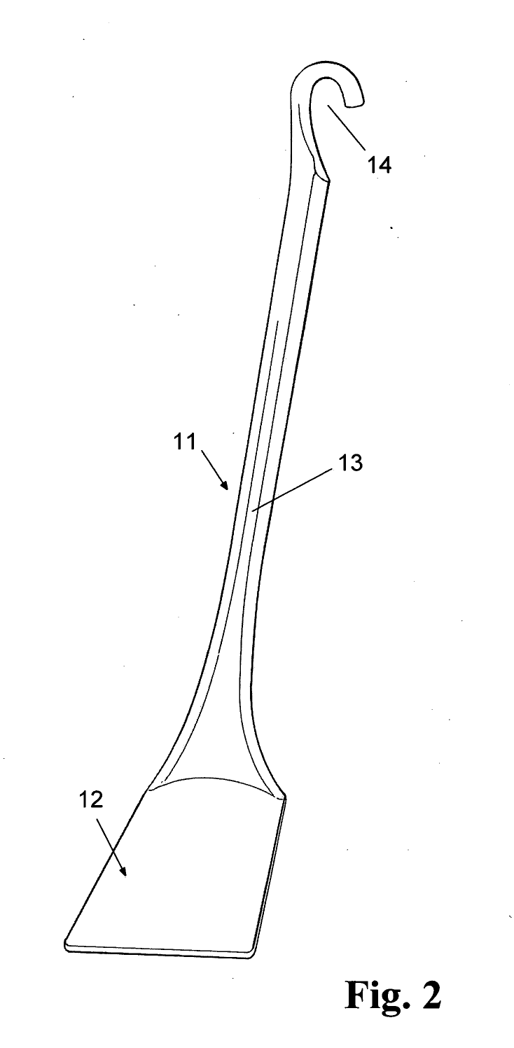

FIG. 2 shows, by the reference number 11, a mixing spatula, comprising an operating spatula part 12 which is made as a single body with the spatula handle 13, said spatula handle also ending with a side hook member 14.

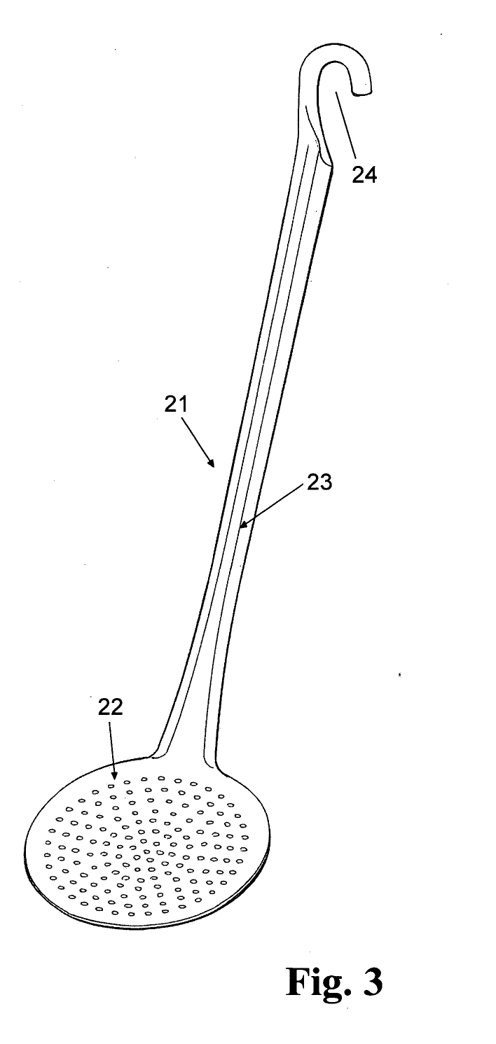

FIG. 3 shows, by the reference number 21, a skimmer, comprising a skimmer operating part 22 made as a single piece with the skimmer handle 23 also ending with the side hook element 24.

It has been found that the invention fully achieves the intended aim and objects.

In fact, the invention has provided a kitchen composite tool or implement construction which is adapted to resist against high temperatures and is very strong and also suitable for making professional kitchen tools.

In practicing the invention, the used materials, as well as the contingent size and shapes, can be any, depending on requirements.

1. A kitchen tool construction, characterized in that said kitchen tool construction comprises a glass fiber reinforced polyamide composite material.

2. A kitchen tool construction, according to claim 1, characterized in that said fiber glass reinforced polyamide composite material comprises “Nylon 6.6”.

3. A kitchen tool construction, according to claim 1, characterized in that said kitchen tool construction comprises an operating part made as a single body with a kitchen tool construction handle, said handle ending with a side hook element.

4. A kitchen tool construction, according to claim 1, characterized in that said kitchen tool construction comprises flour sieving implements, ladles, large spoons, mixing spatulas, whisks, smooth and perforated vanes, skimmers, bread, salad, spaghetti, sweet, sugar springs and grippers.
